(19) United States
(12) Patent Application Publication
(10) Pub. No.: US 2004/0079160 A1
(43) Pub. Date: Apr. 29, 2004

(54) Pressure transducer

(76) Inventors: Martin Geoffrey Aston, Yorkshire (GB); Rodney David Greenough, Bonby (GB); Alan Gordon Ian Jenner, Brough (GB); William John Metheringen, Roos (GB)

Correspondence Address: Wilburn Chesser, Arent Fox Kitner Plotkin & Kahn, Suite 400, 1050 Connenticut Avenue N W, Washington, DC, 20036-6000, US

(21) Appl. No.: 10/332,677

(22) PCT Filed: Jul. 11, 2001
(86) PCT No.: PCT/GB01/03068

(30) Foreign Application Priority Data
Jul. 11, 2000 (GB) 0016852.6

(51) Int. Cl. G01L 9/00

(52) U.S. Cl. 73/753

(57) ABSTRACT

The invention provides a pressure transducer comprising: a closed container (5) having a pair of opposed interior walls (6 and 7) between which is disposed a magnetostrictive element (1); means (9 and 10) to create a magnetic field within the element so as to energise it; and means (11) to detect the resonant frequency of the element, thereby to produce an output indicative of the pressure exerted on the transducer.

### FIELD OF THE INVENTION

The present invention is concerned with transducers capable of detecting pressure or pressure changes. The invention is particularly, but not exclusively, concerned with remote sensors which can be activated so as to signal the pressure to a detector physically separate from the sensor. The invention is also particularly, but not exclusively, concerned with magnetostrictive transducers whose physical dimensions change in dependence on the application of a magnetic field. The invention has particular utility on sensing the pressure in enclosed and inaccessible environments, such as in refuse tips, or in concrete beams and columns.

### BACKGROUND TO THE INVENTION

Magnetostrictive transducers have been used in a variety of applications because of their small size, comparatively large output, reliability and versatility, particularly in hostile or sensitive environments.

An example of the application of magnetostrictive transducers to remotely detecting inter alia pressure changes within a fluid, particularly within the hollow blade of a turbofan gas turbine engine, may be seen in UK Patent Application No 2321105A.

Apart from the limitation of this known device to the measurement only of a variety of parameters, including pressure, within a fluid, the detected output of the transducer can be sensitive to amplitude variations arising from the length of the cable used to couple the transducer to the measurement circuitry.

Other known devices for pressure monitoring use a wire stretched between opposite walls of a closed container. Means are provided to electrically “pluck” the wire, thereby causing it to resonate. The resonant frequency is proportional to the square of the pressure on the outside of the container. An external sensor is able to measure the resonant frequency and thus indicate the pressure exerted on the container.

Difficulties with this design arise because of the need to provide a wide selection of devices with a variety of wire gauges to cover the range of pressures which are required to be measured. Moreover, temperature compensation is necessary if the measured pressures are to be accurate.

There is a need for such a pressure sensor which can be incorporated in hostile and/or inaccessible locations, such as within concrete structures and in refuse tips, and which will be robust, sensitive and accurate and which will operate satisfactorily over a long period.

### SUMMARY OF THE INVENTION

The invention therefore provides a pressure transducer comprising: a closed container having a pair of opposed interior walls between which is disposed a magnetostrictive element; means to create a magnetic field within the element so as to energise it; and means to detect the resonant frequency of the element, thereby to produce an output indicative of the pressure exerted on the transducer.

The element is preferably a rod of giant magnetostrictive material. The ends of the rod may be acoustically isolated from the said walls. The container may be of stainless steel. The element is preferably located within a support tube in such a way as to permit movement of the element within the tube. The element may be partially pre-stressed, for example by means of a screw device accessible from outside the container. The giant magnetostrictive material (GMM) element is suitably of the type comprising an alloy of terbium, dysprosium and iron, although other GMM materials may be used.

The means for creating the magnetic field may comprise one or more annular magnets encircling the element or the tube. The means for energising the element may consist of an electrical coil or winding disposed around the element or the tube and adapted to be remotely activated from outside the container. The means to detect the resonant frequency of the element may consist of a coil or winding disposed around the element or tube and adapted to be remotely sensed from outside the container.

The transducer may be hard-wired into a pressure sensing circuit, but where it is to be located within a fixed structure, it may be possible to induce an energising current into the winding by a remote external coil and to couple the sensing coil to an external coil to detect the resonant frequency.

In either case, the output from the resonant frequency detecting means may be processed by suitable circuitry to enhance the detected signal.

### BRIEF DESCRIPTION OF THE DRAWINGS

The preferred embodiments of the invention will be described with reference to the following drawings, in which:

FIG. 1 shows a transducer according to the invention; and

FIG. 2 shows a modification of the transducer shown in FIG. 1.

### DETAILED DESCRIPTION OF THE ILLUSTRATED EMBODIMENTS

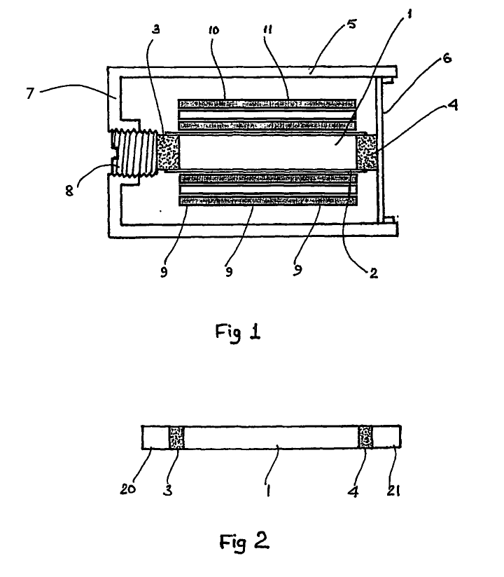

The transducer shown in FIG. 1 is primarily designed to be located in a refuse tip or to be cast into a concrete structure, typically a beam or a column, where it will be used to detect the pressure exerted on it. The transducer includes a GMM rod 1. The rod is loosely disposed within a support tube 2 of suitable non-magnetic material. At each end of the tube is an acoustic isolator 3,4 whose purpose is to prevent or at least reduce the acoustic frequencies in the rod from being coupled to the exterior space around the device. If coupling were to occur, damping of the signal would result, reducing the sensitivity of the device.

The tube 2 is located in a non-magnetic container 5, for example of stainless steel. The container may be cylindrical to match the shape of the rod, for the sake of compactness, but can be of any other convenient shape. The container should also be substantially rigid except for one end wall 6 which needs to be flexible, in the sense of acting as a diaphragm so that variations in external pressure are transmitted to the ends of the rod 1. The flexible end wall 6 may be of thinner stainless steel than the remainder of the container or could be of a different material exhibiting inherently more flexibility, such as brass for example.

The end of the rod closest to the flexible wall 6 is in close contact with it to ensure the effective transfer of external pressure to the rod. The other end of the rod could likewise be in close contact with the opposite end wall 7 of the container. However, it is preferable, as shown in FIG. 1, for the other end of the rod to bear against an adjustable screw 8 threaded into a tapped hole in the opposite end wall 7 and accessible from outside the container. Adjustment of the position of the screw will cause the rod to be pre-stressed by an amount which can be selected so as to adjust the base resonance frequency of the rod.

One or more annular permanent magnets 9 are located over the tube 2 to create a bias magnetic field within the rod. One such magnets is shown in FIG. 1 but any convenient number can be provided, dependent on the application and the required sensitivity. Similarly, one or more energising coils or windings 10 and one or more pick-up coils or windings 11 are also located over the tube.

The Youngs modulus of the material of the rod varies as a linear function of the applied pressure, thereby causing the speed of sound within the rod to vary. Consequently, the resonant frequency of the rod changes as a linear function of the applied pressure. In order to operate the invention, therefore, the rod is activated by supplying an alternating frequency to energise the coil 10 and the resonant frequency of the rod is sensed by means of the pick-up coils 11. Remote sensing of the resonant frequency is possible and in some applications is essential, especially when the device is buried in concrete. Under such circumstances, separate energising and pick-up coils are brought close to the device from outside the container or outside the concrete structure in which the device is buried, and the process of energising and sensing carried out by inductive transmission and sensing. It is possible for the same coil to be used for both energising and sensing.

The device described above has a wider range of frequency coverage than prior devices. However, it may still be preferable to provide a variety of devices tailored to different frequency bands. In this case, transducers will be made with variations in rod lengths and/or cross sectional areas, thereby “tuning” the devices to cover different ranges of resonant frequency.

The transducer may be modified by the addition of metal end pieces 20, 21 disposed at the ends of the acoustic isolators 3, 4. The metal end pieces are preferably of non-magnetic material, such as stainless steel or brass. They can improve the coupling with the container walls but without the acoustic frequencies in the rod being coupled to the exterior space around the device which would otherwise cause damping and thus reduce sensitivity.

1. A pressure transducer comprising: a closed container having a pair of opposed interior walls between which is disposed a magnetostrictive element; means to create a magnetic field within the element so as to energise it; and means to detect the resonant frequency of the element, thereby to produce an output indicative of the pressure exerted on the transducer.

2. A pressure transducer according to claim 1, wherein the element is a rod of giant magnetostrictive material.

3. A pressure transducer according to claim 1 or 2, wherein the rod is acoustically isolated from the said walls.

4. A pressure transducer according to claim 1, 2 or 3, wherein the container is formed of stainless steel.

5. A pressure transducer according to any preceding claim, wherein the element is located within a support tube in such a way as to permit movement of the element within the tube.

6. A pressure transducer according to any preceding claim, wherein the element is pre-stressed.

7. A pressure transducer according to claim 6, wherein the element is pre-stressed by means of a screw device accessible from outside the container.

8. A pressure transducer according to any preceding claim, wherein the means for creating the magnetic field comprise one or more annular magnets encircling the element.

9. A pressure transducer according to any preceding claim, wherein the means for energising the element comprise an electrical coil disposed around the element.

10. A pressure transducer according to any preceding claim, wherein the means to detect the resonant frequency of the element consists of a coil disposed around the element and adapted to be remotely sensed from outside the container.

11. A pressure transducer according to any preceding claim, comprising a remote external coil connected to a power supply and arranged to induce an energising current into the energising means.

12. A pressure transducer according to claim 11, wherein the remote external coil is also connectable to sensing means to detect and measure the output of the sensing coil within the container.
